(19) United States
(12) Patent Application Publication
(10) Pub. No.: US 2012/0144967 A1
(43) Pub. Date: Jun. 14, 2012

(54) TAIL SPINDLE OF LATHE INCLUDING OIL HYDRAULIC CIRCUIT FOR THRUST COMPENSATION

(75) Inventors: Dong Seog KIM, Changwon-si (KR); Han Gil JANG, Changwon-si (KR)

(73) Assignee: HANKOOK MACHINE TOOLS CO., LTD., Changwon-si (KR)

(21) Appl. No.: 13/324,428

(22) Filed: Dec. 13, 2011

(30) Foreign Application Priority Data
Dec. 14, 2010 (KR) 10-2010-0127570

(51) Int. Cl. B23B 23/00

(52) U.S. Cl. 82/148

(57) ABSTRACT

The present invention relates to the trail spindle of a lathe including an oil hydraulic circuit for thrust compensation, wherein lathe turning operations on a processing object can be performed always accurately by preventing the processing object from being swung and the shape of the processing object from being deformed, in such a manner that necessary thrust is generated by using an oil hydraulic cylinder and a pressure reducing and relieving valve without using the existing method of moving a tail spindle using a screw and the oil hydraulic circuit automatically performs thrust compensation (i.e., maintains constant thrust) according to a change in the length of the processing object during lathe turning operations.

This application claims the benefit of priority of Korean Patent Application No. 10-2010-0127570 filed on Dec. 14, 2010, which is incorporated by reference in their entirety herein.

1. Field of the Invention

The present invention relates to the trail spindle of a lathe including an oil hydraulic circuit for thrust compensation and, more particularly, to the trail spindle of a lathe including an oil hydraulic circuit for thrust compensation, which can automatically perform thrust compensation (maintain constant thrust) according to a change in the length of a processing object during lathe turning operations.

2. Background of the Invention

As well known, a horizontal lathe refers to a machine in which a cylindrical object to be processed is fixed between a main shaft post and a tailstock both of which are horizontally placed and a tool rest is moved left and right and forward and backward to perform lathe turning operations on a processing object.

The main shaft post functions to fix and rotate the processing object by using a chuck. The tailstock functions to push the processing object by specific thrust by using a tail spindle in order to prevent the processing object from swinging during processing.

In a current tail spindle structure, however, a screw moves the tail spindle forward or backward, and a load cell fixes the position of the tail spindle according to necessary thrust.

If the time that it takes to process the processing object becomes long or thermal deformation occurs in the processing object depending on a processing condition, the length of the processing object is changed, and thus the thrust of the tail spindle is varied. Consequently, there are problems in that the processing object is swung and at the same time the degree of processing of the processing object is bad.

A conventional tailstock structure applied to the horizontal lathe is described below.

As shown in FIG. 1, in the horizontal lathe, a processing object 4 to be processed is placed between a main shaft post 1 and a tailstock 2, and a tool rest 3 to which a tool, such as a bite, has been clamped processes the processing object 4 fixed to a main shaft 1-1 according to a program previously inputted to a control unit 5 while moving left and right and forward and backward.

As shown in FIG. 4, in the conventional tailstock 2 applied to the above horizontal lathe, a tail spindle 2-1 in which a center 9 is stuck rotates and forward and backward moves a feed screw 6. Thrust generated in the tail spindle 2-1 at the moment when the center 9 comes in contact with the processing object in order to fix the position of the tail spindle 2-1 is applied to a load cell 7 placed in the middle portion of the feed screw 6. The thrust detected by the load cell is converted into a unit of force and then displayed in a digital indicator 8 (i.e., a display device).

In adjusting the position of the tail spindle of the tailstock, there is no problem in setting the first necessary thrust. However, there is a problem in that the thrust cannot be adjusted without stopping processing when there is a change of the thrust that may occur during processing.

That is, if the length of the processing object is changed by heat generated during lathe turning operations, the thrust of the tail spindle, pushing the processing object, is changed. If the thrust of the tail spindle is reduced (if force pushing the processing object becomes weak), the rotating object to be processed is swung. If the thrust of the tail spindle is increased, however, the shape of the object placed between the main shaft post and the tail spindle is deformed. Consequently, both the cases have an adverse effect on the degree of processing.

### SUMMARY OF THE INVENTION

Accordingly, the present invention has been made keeping in mind the above problems occurring in the prior art, and an object of the present invention is to provide the trail spindle of a lathe including an oil hydraulic circuit for thrust compensation, wherein lathe turning operations on a processing object can be performed always accurately by preventing the processing object from being swung and the shape of the processing object from being deformed, in such a manner that necessary thrust is generated by using an oil hydraulic cylinder and a pressure reducing and relieving valve without using the existing method of moving a tail spindle using a screw and the oil hydraulic circuit automatically performs thrust compensation (i.e., maintains constant thrust) according to a change in the length of the processing object during lathe turning operations.

In order to achieve the object, the present invention provides the trail spindle of a lathe including an oil hydraulic circuit for thrust compensation, including a cylinder rod integrally coupled to a rear of the tail spindle; an oil hydraulic cylinder configured to comprise a piston coupled to a rear of the cylinder rod; and the oil hydraulic circuit configured to receive and discharge a hydraulic oil through the hydraulic oil inflow port and the hydraulic oil exhaust port of the oil hydraulic cylinder, wherein the tail spindle moves a processing object forward or backward along with the cylinder rod by means of the movement of the piston of the oil hydraulic cylinder.

As a preferred implementation example of the present invention, the oil hydraulic circuit includes a first oil hydraulic circuit unit for controlling the forward or backward operation of the tail spindle and a second oil hydraulic circuit unit (i.e., a thrust compensation circuit) for pushing the tail spindle by constant force.

The first oil hydraulic circuit unit comprises a pressure reducing valve, a solenoid valve, a pilot operation check modular valve, and a throttle and check modular valve which are sequentially coupled along a direction where the hydraulic oil is supplied to the hydraulic oil inflow port or the hydraulic oil exhaust port of the oil hydraulic cylinder.

Furthermore, the second oil hydraulic circuit unit includes a first solenoid valve, a throttle and check modular valve, a pressure reducing and relieving valve, and a second solenoid valve which are sequentially coupled along a direction where the hydraulic oil is supplied to the hydraulic oil inflow port of the oil hydraulic cylinder.

A pressure gauge for indicating a pressure of the hydraulic oil and a pressure sensor for detecting the amount of thrust generated in the tail spindle are disposed on an outlet side of the pressure reducing and relieving valve.

### BRIEF DESCRIPTION OF THE DRAWINGS

The above and other objects and features of the present invention will become apparent from the following description of preferred embodiments given in conjunction with the accompanying drawings, in which:

FIG. 1 is a front view showing a horizontal lathe including a trail spindle;

FIG. 2 is a front view showing the cross-sectional view of part of the trail spindle of a lathe including an oil hydraulic circuit for thrust compensation according to the present invention;

FIG. 3 shows the oil hydraulic circuit for thrust compensation applied to the trail spindle of a lathe according to the present invention; and

FIG. 4 is a front view showing part of a conventional trail spindle applied to a lathe.

<Description of reference numerals of principal elements in the drawings>

| | | |
|---|---|---|
| 1: main shaft post | 1-1: main shaft | |
| 2: tailstock | 2-1: tail spindle | |
| 3: tool rest | 4: the processing | |
| | object | |
| 5: control unit | 6: feed screw | |
| 7: load cell | 8: digital indicator | |
| 9: center | 10: cylinder rod | |
| 11: oil hydraulic cylinder | 11-1: piston | |
| 12-1: hydraulic oil inflow port | | |
| 12-2: hydraulic oil exhaust | | |
| port | | |
| 13: pressure reducing valve | 14: solenoid valve | |
| 15: pilot operation check | | |
| modular valve | | |
| 16: throttle and check | | |
| modular valve | | |
| 17: oil hydraulic supply line | 18: first solenoid | 19: throttle and |
| | valve | check modular valve |
| 20: check valve | | |
| 21: pressure reducing and | | |
| relieving valve | | |
| 22: pressure sensor | 22-1: pressure gauge | |
| 23: second solenoid valve | | |
| 100: first oil hydraulic | | |
| circuit unit | | |
| 200: second oil hydraulic | | |
| circuit unit | | |

### DETAILED DESCRIPTION OF THE EMBODIMENTS

Hereinafter, an exemplary embodiment of the present invention will be described in detail with reference to the accompanying drawings.

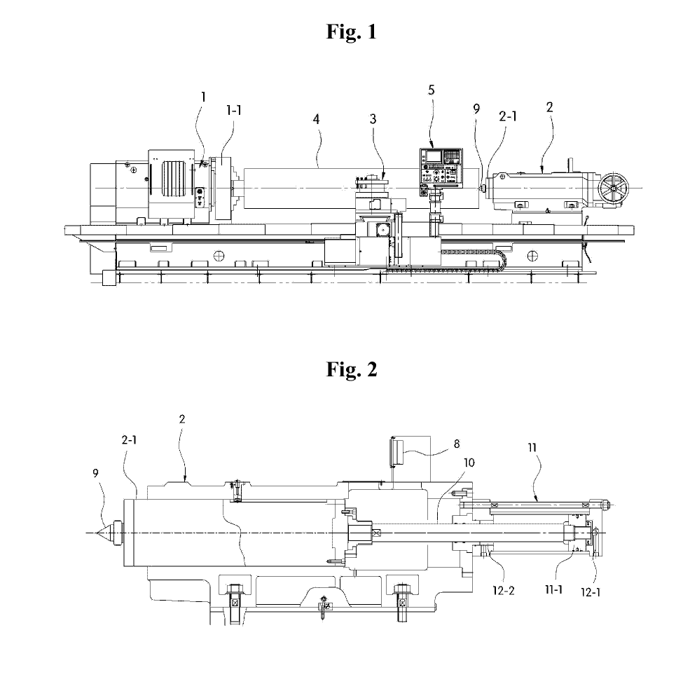

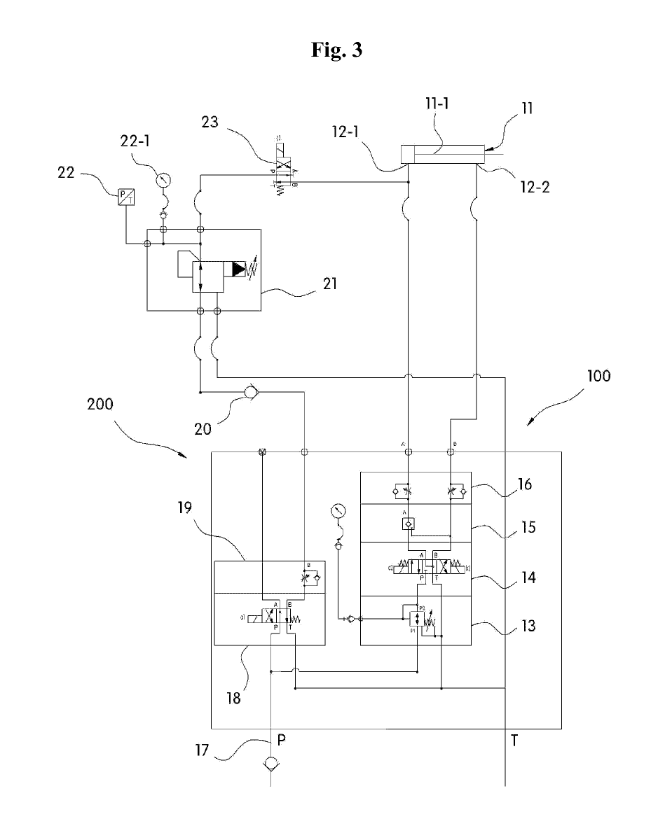

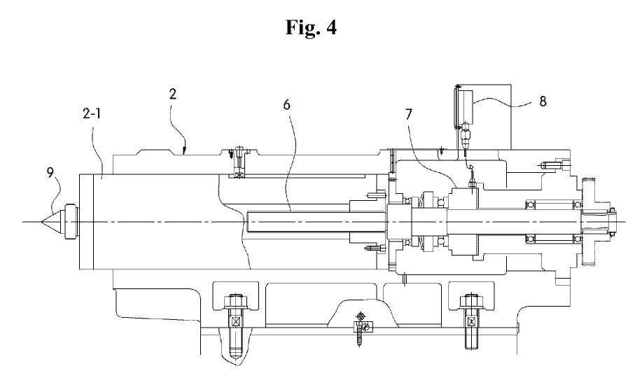

As described above with reference to FIG. 1, a horizontal lathe refers to an apparatus in which a processing object 4 to be processed is placed between a main shaft post 1 and a tailstock 2, and a tool rest 3 to which a tool, such as a bite, has been clamped processes the processing object 4 fixed to a main shaft 1-1 according to a program previously inputted to a control unit 5 while moving left and right and forward and backward.

The present invention is intended to improve a tail spindle 2-1 within the tailstock 2 in the elements of the lathe and to further provide the trail spindle capable of pushing the processing object by constant thrust against thermal deformation of the processing object which is generated during lathe turning operations.

In other words, the present invention focuses on the trail spindle of a lathe including an oil hydraulic circuit for thrust compensation, wherein necessary thrust is generated by using an oil hydraulic cylinder and a pressure reducing and relieving valve without using the existing method of moving the tail spindle and the oil hydraulic circuit automatically performs thrust compensation (i.e., maintains constant thrust) according to a change in the length of a processing object during lathe turning operations such that the processing object can be easily pushed in order to prevent the processing object from being swung or dropped and the amount of pushing force (i.e., thrust) can be differently adjusted according to the weight of the processing object during lathe turning processing.

The trail spindle of a lathe including the oil hydraulic circuit for thrust compensation according to the present invention is described in detail below with reference to FIG. 2.

The tail spindle 2-1 according to the present invention adopts an oil hydraulic cylinder 11 operated by a hydraulic oil, instead of the existing feed screw used to move the tail spindle forward or backward. The front tip of the cylinder rod 10 of the oil hydraulic cylinder 11 is coupled to the rear of the tail spindle 2-1 so that a hydraulic oil is made to flow in or discharged through the hydraulic oil inflow port and exhaust ports 12-1 and 12-2 of the oil hydraulic cylinder 11. Accordingly, the tail spindle 2-1 attached to the tip of the cylinder rod 10 is moved forward or backward by the movement of a piston 11-1 coupled to the cylinder rod 10 of the oil hydraulic cylinder 11.

When the hydraulic oil flows through the hydraulic oil inflow port 12-1 and the hydraulic oil is discharged through the hydraulic oil exhaust port 12-2, the tail spindle is moved forward. When the hydraulic oil flows through the hydraulic oil exhaust port 12-2 and the hydraulic oil is discharged through the hydraulic oil inflow port 12-1, the tail spindle is moved backward.

In particular, the present invention includes the oil hydraulic circuit for supplying the hydraulic oil to the hydraulic oil inflow port 12-1 of the oil hydraulic cylinder 11 or discharging the hydraulic oil through the hydraulic oil exhaust port 12-2.

The oil hydraulic circuit may include a first oil hydraulic circuit unit 100 for controlling the forward or backward operation of the tail spindle 2-1 and the second oil hydraulic circuit unit 200 (i.e., a thrust compensation circuit) for pushing the tail spindle 2-1 by constant force.

The first oil hydraulic circuit unit 100 includes a solenoid valve 14 and a plurality of modular valves 13, 14, 15, and 16 for controlling the forward or backward operation of the tail spindle 2-1.

That is, the pressure reducing valve 13, the solenoid valve 14, the pilot operation check modular valve 15, and the throttle and check modular valve 16 are sequentially arranged along a direction where the hydraulic oil is supplied from additional hydraulic nuts (not shown).

Accordingly, when the hydraulic oil is supplied through a supply line 17 from the additional hydraulic nuts (not shown), the pressure reducing valve 13 decompress the hydraulic oil to pressure suitable to move the tail spindle, and the solenoid valve 14 selects a direction where the cylinder will move forward or backward.

Next, when the hydraulic oil passes through the throttle and check modular valve 16, the speed of forward or backward movement of the tail spindle is controlled and thus the hydraulic oil is introduced into the cylinder through the hydraulic oil inflow port 12-1 or the hydraulic oil exhaust port 12-2 of the oil hydraulic cylinder 11. Accordingly, the piston 11-1 is moved forward or backward, and at the same time the tail spindle 2-1 moves forward or backward along with the cylinder rod 10 integrated with the piston 11-1.

At this time, the pilot operation check modular valve 15 does not influence the movement of the tail spindle in case of a normal hydraulic oil flow, but functions to prevent the hydraulic oil, moving the cylinder forward, from being recovered by the hydraulic nuts when the solenoid valve 14 is turned off or the hydraulic nuts (i.e., a source of a hydraulic oil) stops operating owing to a power failure or other causes.

The second oil hydraulic circuit unit 200 (i.e., a thrust compensation circuit) for pushing the tail spindle by constant force is described below.

The second oil hydraulic circuit unit 200 includes a first solenoid valve 18 coupled to the oil hydraulic supply line 17, a the second solenoid valve 23 coupled to the hydraulic oil inflow port 12-1 of the cylinder, a throttle and check modular valve 19 modulated with the first solenoid valve 18, and a pressure reducing and relieving valve 21 coupled between the second solenoid valve 23 and the throttle and check modular valve 19.

Furthermore, a pressure gauge 22-1 for indicating the pressure of hydraulic oil and a pressure sensor 22 for detecting the amount of thrust generated in the tail spindle are mounted on the side of the outlet of the pressure reducing and relieving valve 21. An electric signal outputted from the pressure sensor 22 is converted into the unit of force through a digital indicator 8 and then displayed.

Meanwhile, a check valve 20 for preventing the inverse flow of the hydraulic oil is disposed between the outlet side of the throttle and check modular valve 16 and the inlet side of the pressure reducing and relieving valve 21.

The principle of the thrust compensation operation of the tail spindle according to the first and the second oil hydraulic circuit units 100 and 200 is described below.

First, when the hydraulic oil generated from the additional hydraulic nuts (not shown) is supplied via the supply line 17 as described above, the hydraulic oil is supplied through the hydraulic oil inflow port 12-1 or the hydraulic oil exhaust port 12-2 of the oil hydraulic cylinder 11 through a process in which the pressure reducing valve 13 decompresses the hydraulic oil so that the tail spindle can suitably move, a process in which the solenoid valve 14 selects a direction where the cylinder will move forward or backward, and a process in which the pressure of the hydraulic oil is controlled so that the speed of the forward or backward movement of the tail spindle can be controlled when the hydraulic oil passes through the throttle and check modular valve 16. Accordingly, the tail spindle 2-1 moves forward or backward along with the cylinder rod 10 integrated with the piston 11-1.

After the center 9 moves the tail spindle 2-1 up to an appropriate position before the center 9 comes in contact with the processing object stuck in the tail spindle 2-1 while moving the tail spindle 2-1 forward or backward, the solenoid valve 14 is turned off and, at the same time, the first and the second solenoid valves 18 and 23 of the second oil hydraulic circuit unit 200 (i.e., the thrust compensation oil hydraulic circuit) are turned off, so that the hydraulic oil is supplied to the hydraulic oil inflow port 12-1 of the cylinder. Accordingly, the tail spindle 2-1 is moved forward along with the cylinder rod 10 integrated with the piston 11-1, and the center 9 stuck in the tail spindle 2-1 comes in contact with the processing object in proper pressure.

At this time, the pressure of the hydraulic oil is controlled according to the speed that the tail spindle moves forward while the hydraulic oil passes through the throttle and check modular valve 19. The pressure reducing and relieving valve 21 functions to control the decompression of the hydraulic oil at constant pressure in order to provide constant thrust to the tail spindle.

Furthermore, the amount of thrust generated in the tail spindle and the pressure of hydraulic oil on the outlet side of the pressure reducing and relieving valve 21 are converted into the unit of force and then displayed through the digital indicator 8 as described above. Accordingly, thrust necessary for the tail spindle can be controlled at a desired level by controlling the degree of opening and shutting of the pressure reducing and relieving valve on the basis of the amount of thrust and the pressure of hydraulic oil.

As described above, since constant pressure is maintained against a change of pressure generated between the pressure reducing and relieving valve 21 and the hydraulic oil inflow port 12-1 of the cylinder, thrust compensation for the tail spindle can be smoothly performed.

Accordingly, if the thrust of the tail spindle is changed according to a change in the length of the processing object owing to the thermal deformation of a processing object during the lathe turning operations of the horizontal lathe, the tail spindle can support the processing object by always the same thrust because the second oil hydraulic circuit unit 200 performs the thrust compensation operation as described above.

As described above, the present invention has the following advantages.

According to the present invention, automatic thrust compensation can be performed (i.e., constant thrust can be maintained) against a change in the length of a processing object due to heat generated during lathe turning operations by improving a method of generating necessary thrust using the oil hydraulic cylinder and the pressure reducing and relieving valve instead of the existing method of moving the tail spindle using the screw.

As described above, the tail spindle supports the processing object by always constant force through automatic thrust compensation for the tail spindle. Accordingly, the processing object can be prevented from being swung and deformed and lathe turning operations on the processing object can always be accurately performed.

While the invention has been shown and described with respect to the preferred embodiments, it will be understood by those skilled in the art that various changes and modifications may be made without departing from the spirit and scope of the invention as defined in the following claims.

What is claimed is:

1. A trail spindle of a lathe including an oil hydraulic circuit for thrust compensation, the trail spindle comprising:
a cylinder rod 10 integrally coupled to a rear of the tail spindle 2-1;
an oil hydraulic cylinder 11 configured to comprise a piston 11-1 coupled to a rear of the cylinder rod 10; and
the oil hydraulic circuit configured to receive and discharge a hydraulic oil through a hydraulic oil inflow port 12-1 and a hydraulic oil exhaust port 12-2 of the oil hydraulic cylinder 11,
wherein the tail spindle 2-1 moves a processing object forward or backward along with the cylinder rod 10 by means of a movement of the piston 11-1 of the oil hydraulic cylinder 11.

2. The trail spindle of a lathe of claim 1, wherein the oil hydraulic circuit comprises:
a first oil hydraulic circuit unit 100 for controlling the forward or backward operation of the tail spindle 2-1; and
a second oil hydraulic circuit unit 200 which is a thrust compensation circuit for pushing the tail spindle 2-1 by constant force.

3. The trail spindle of a lathe of claim 2, wherein the first oil hydraulic circuit unit 100 comprises a pressure reducing valve 13, a solenoid valve 14, a pilot operation check modular valve 15, and a throttle and check modular valve 16 which are sequentially coupled along a direction where the hydraulic oil is supplied to the hydraulic oil inflow port 12-1 or the hydraulic oil exhaust port 12-2 of the oil hydraulic cylinder 11.

4. The trail spindle of a lathe of claim 2, wherein the second oil hydraulic circuit unit 200 comprises a first solenoid valve 18, a throttle and check modular valve 19, a pressure reducing and relieving valve 21, and a second solenoid valve 23 which are sequentially coupled along a direction where the hydraulic oil is supplied to the hydraulic oil inflow port 12-1 of the oil hydraulic cylinder 11.

5. The trail spindle of a lathe of claim 4, wherein a pressure gauge 22-1 for indicating a pressure of the hydraulic oil and a pressure sensor 22 for detecting an amount of thrust generated in the tail spindle are disposed on an outlet side of the pressure reducing and relieving valve 21.
